(19) United States
(12) Patent Application Publication
(10) Pub. No.: US 2025/0190187 A1
(43) Pub. Date: Jun. 12, 2025

(54) METHOD FOR DATA TYPE DRIVEN FRONT-END RENDERING

(71) Applicant: INTERNATIONAL BUSINESS MACHINES CORPORATION, Armonk, NY (US)

(72) Inventors: Kuan Yu Hsieh, Pitou (TW); Bo Wen, Chappaqua, NY (US); VINCE SIU, Thornhill (CN); Chen Wang, Chappaqua, NY (US)

(21) Appl. No.: 18/534,920

(22) Filed: Dec. 11, 2023

(51) Int. Cl. G06F 8/38; G06F 9/451; G06F 21/62

(52) U.S. Cl. CPC G06F 8/38; G06F 9/451; G06F 21/629

(57) ABSTRACT

According to embodiments, a computer-implemented method may include the steps of receiving, by a processor set and through a back-end user interface, input data including at least one prompt type and at least one associated answer type, wherein the at least one prompt type and at least one associated answer type define aspects of a front-end user interface; generating, by the processor set, rendering instructions based on the at least one prompt type and at least one associated answer type; receiving, by the processor set and from a front-end platform, a request to view the front-end user interface; and in response to receiving the request to view the front-end user interface, communicating, by the processor set, the rendering instructions to the front-end platform, wherein the rendering instructions cause the front-end platform to dynamically render the front-end user interface.

### BACKGROUND

Aspects of the present invention relate generally to systems and methods for rendering user interfaces (UI) via computer program front-end development frameworks, such as model-view-controllers (MVC).

MVC's may be utilized as front-end development frameworks for creating and rendering UIs. Architecture patterns associated with MVC's provide low-level widgets accessible to users for constructing front-end UI's and views but are unable to run code by a rendering or processing engine.

### SUMMARY

In a first aspect of the invention, there is a computer-implemented method including: receiving, by a processor set and through a back-end UI, input data including at least one prompt type and at least one associated answer type, wherein the at least one prompt type and at least one associated answer type define aspects of a front-end UI; generating, by the processor set, rendering instructions based on the at least one prompt type and at least one associated answer type; receiving, by the processor set and from a front-end platform, a request to view the front-end UI; and in response to receiving the request to view the front-end UI, communicating, by the processor set, the rendering instructions to the front-end platform, wherein the rendering instructions cause the front-end platform to dynamically render the front-end UI.

In another aspect of the invention, there is a computer program product including one or more computer readable storage media having program instructions collectively stored on the one or more computer readable storage media. The program instructions are executable to: receive, through a back-end user interface, input data comprising at least one prompt type and at least one associated answer type, wherein the at least one prompt type and at least one associated answer type define aspects of a front-end user interface; generate rendering instructions based on the at least one prompt type and at least one associated answer type; receive, from a front-end platform, a request to view the front-end user interface; and in response to receiving the request to view the front-end user interface, communicate the rendering instructions to the front-end platform, wherein the rendering instructions cause the front-end platform to dynamically render the front-end user interface.

In another aspect of the invention, there is a system including a processor set, one or more computer readable storage media, and program instructions collectively stored on the one or more computer readable storage media. The program instructions are executable to: receive, through a back-end user interface, input data comprising at least one prompt type and at least one associated answer type, wherein the at least one prompt type and at least one associated answer type define aspects of a front-end user interface; generate rendering instructions based on the at least one prompt type and at least one associated answer type; receive, from a front-end platform, a request to view the front-end user interface; and in response to receiving the request to view the front-end user interface, communicate the rendering instructions to the front-end platform, wherein the rendering instructions cause the front-end platform to dynamically render the front-end user interface.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2A shows a block diagram of an exemplary computing environment in accordance with aspects of the present invention.

FIG. 2B shows a block diagram of an exemplary computing environment in accordance with aspects of the present invention.

FIG. 3 shows a flowchart of a computer-implemented method in accordance with aspects of the present invention.

FIG. 4 shows a flowchart of a computer-implemented method in accordance with aspects of the present invention.

FIG. 5 shows a diagram of a computer-implemented method in accordance with aspects of the present invention.

FIG. 6 shows a diagram of a computer-implemented method in accordance with aspects of the present invention.

FIG. 7 shows a diagram of a computer-implemented method in accordance with aspects of the present invention.

FIG. 8 shows a diagram of a computer-implemented method in accordance with aspects of the present invention.

FIG. 9 shows a diagram of a computer-implemented method in accordance with aspects of the present invention.

FIG. 10 shows a diagram of a computer-implemented method in accordance with aspects of the present invention.

FIG. 11 shows a flowchart of program executables in accordance with aspects of the present invention.

### DETAILED DESCRIPTION

Aspects of the present invention relate generally to methods of rendering front-end UIs for mobile or web browser applications where the UI that a user sees is dynamically rendered based on the task or content and rendering instructions. The system and method may enable updates to be made on all instances of an application without requiring a developer to distribute a new application file for the user to install or update in order to experience new application features.

In embodiments, the system may include a front-end UI dynamic rendering code in which web page templates and UI view widgets may be constructed within a front-end container. The UI presented to a user via a computing device display may be dynamically rendered, via at least one processor, based on data type and associated rendering instruction from the system. New data types and rendering instructions can be created and communicated to the system, such as via over a network, without the need to change the source code or rebuild the front-end application.

MVC's are common front-end development frameworks for creating UIs, but the architecture patterns associated with MVC's provide low-level widgets accessible to users for constructing front-end UI's and views. For security reasons, data and code may be strictly separated within an MVC. If data contains code, the code may not be run by the rendering or processing engine.

Constructing front-end UI's is a labor-intensive process for developers required to code individual pages, such as in use cases like health care questionnaires or tasks. Implementations of the disclosed system allow for use cases where data collection tasks have an expanding usage application, such as deploying new healthcare questionnaires, tasks, or tests during clinical studies or presenting new analysis dashboards in financial reports.

In embodiments, the disclosed system may be configured to allow pre-identified “superusers,” such as administrative users or users desirous of constructing front-end UIs, with increased flexibility for generating UIs and expand the system's useful lifespan by allowing superusers to provide code snippets as part of their data content when generating a UI. In this way, the system may include computer product programming to facilitate front-end UI layout template generation and widgets dynamically constructed based on both non-code input and code snippet submission. In embodiments, the system allows rendering different types of user interaction components, including input or output components such as radio buttons, text input, video or audio recording, instead of merely context, text, or image components to a UI.

In embodiments, a method of dynamically rendering an interface to a front-end user may include receiving task prompts, such as prompt types, and associated input prompts, such as answer types, (e.g., task visualization response options such as single or multiple-choice questions, sliding scale selection, and text, image, audio, or video prompts) from a back-end UI. The method may include receiving a request to view the interface on a device and dynamically rendering different types of user interaction components.

In embodiments, a method of dynamically rendering an interface to a front-end user may include receiving a request to view the task on the interface; displaying the question prompt to the front-end user; receiving an answer to the question prompt; customizing the interface by rendering different types of user interaction components that can be for either input or output (radio button, text input, or audio recording) instead of solely delivering context, text, image based on the task and the answer; detecting credentials of a superuser at the back end; detecting whether the front-end user is using a Web-based interface that supports JavaScript/CSS, or a mobile interface, wherein when the front-end user is using a Web-based interface, the backend will process the code and modify the payload to include appropriate JavaScript/CSS that's being sent to the frontend, and when the front-end user is using a mobile platform, using a cross-platform development framework to allow the superuser to write their code snippet in JavaScript/CSS; and compiling the code snippet in a format that the frontend rendering platform can process correctly.

As a non-limiting example, cross-platform development frameworks may include the development of software applications, using a single codebase, compatible to work with several different operating systems, such as on various mobile-device operating systems.

In embodiments, front-end UI elements, such as interaction components, of software platforms visualize end-to-end data pipelines that may move data through stages such as, but not limited to, data ingestion, data storage, data analytics, and data access. Software platforms may be connected, such as over wireless networks, to mobile applications, wearables, or Internet of Things (IoT) devices to collect and ingest data into a secure database. The rendering of front-end UIs, such as those displayed on computing devices in a mobile or web browser application, may be accomplished dynamically based on the content and rendering instructions provided by the system. This enables updates to be made on instances of software applications, including UI updates, without requiring a developer user to distribute a new application file which would require a consumer user to install or update to experience new UI features.

In embodiments, back-end users, such as the superusers, with little to no development or software coding background may control task, survey, or questionnaire contents delivered to all users, including users exposed to and interacting with the front-end UI. Back-end users may create task visualization elements including task prompts and associated input prompts (e.g., question prompts and answer prompts) within the UI by selecting from a list of various task visualization response options including, but not limited to single or multiple-choice questions; sliding scale selections; text, image, audio, or video prompts; or the like.

In embodiments, back-end users familiar with software coding or development may utilize code snippets to control front-end UI element dynamic rendering that may be unsupported by the list of various task visualization response options.

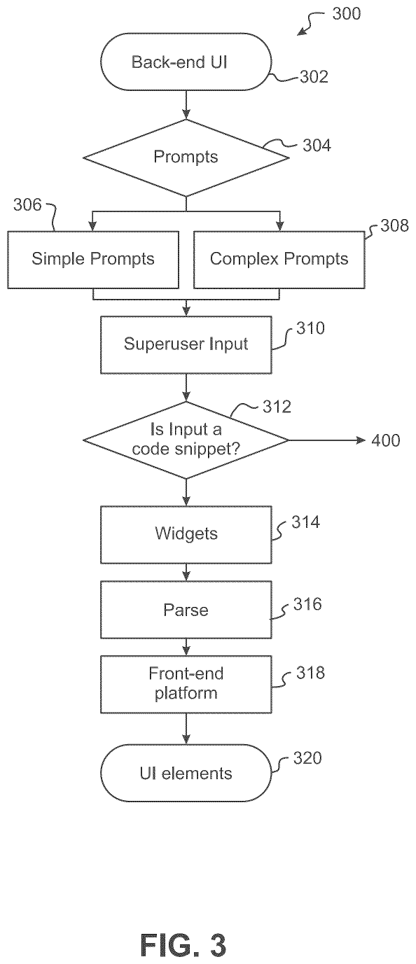

According to embodiments, and as depicted in FIGS. 3 and 5-9, dynamic rendering may include converting data from a first format, such as text input, into a structured format adhering to JavaScript object notation (JSON) standards. The system may receive superuser input identifying task prompts and input prompts to be dynamically rendered in a UI display on a user device.

According to embodiments, dynamic rendering may include converting input data, such as text input, into a JSON-compatible structure following JSON syntax rules. This process may include data conversion, serialization, or validation, among other steps. Dynamic rendering may further include communicating JSON formatted input data, such as in the form of rendering instructions, to a front-end platform which may render predefined widgets in a front-end UI on a display based on superuser input of task prompts and associated input prompts.

According to embodiments, dynamic rendering may include utilizing predefined question types in pre-built widgets. Pre-built widgets may determine how task prompts and input prompts are displayed when dynamically rendered on a front-end UI. Superuser input may be converted into a JSON standard and parsed into pre-built widgets via tokenization, analysis, extraction, error handling, transformation, or validation, among other steps.

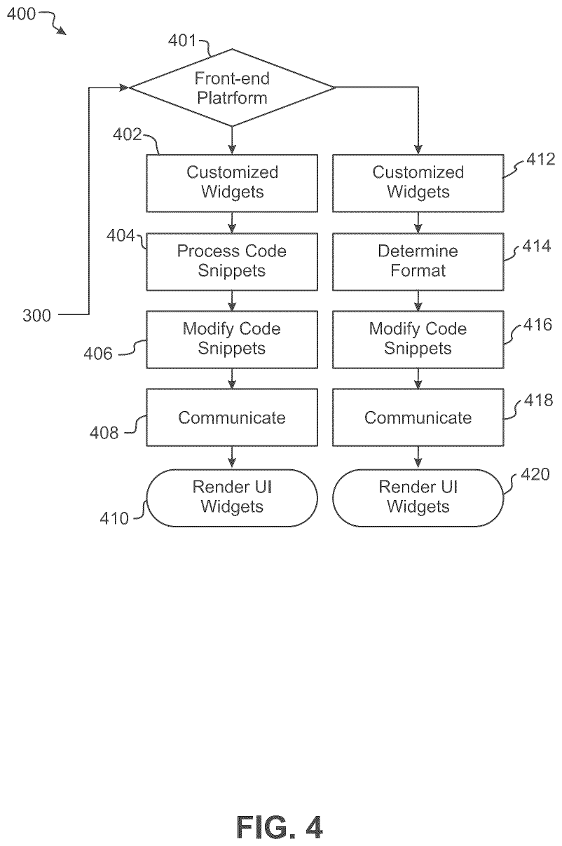

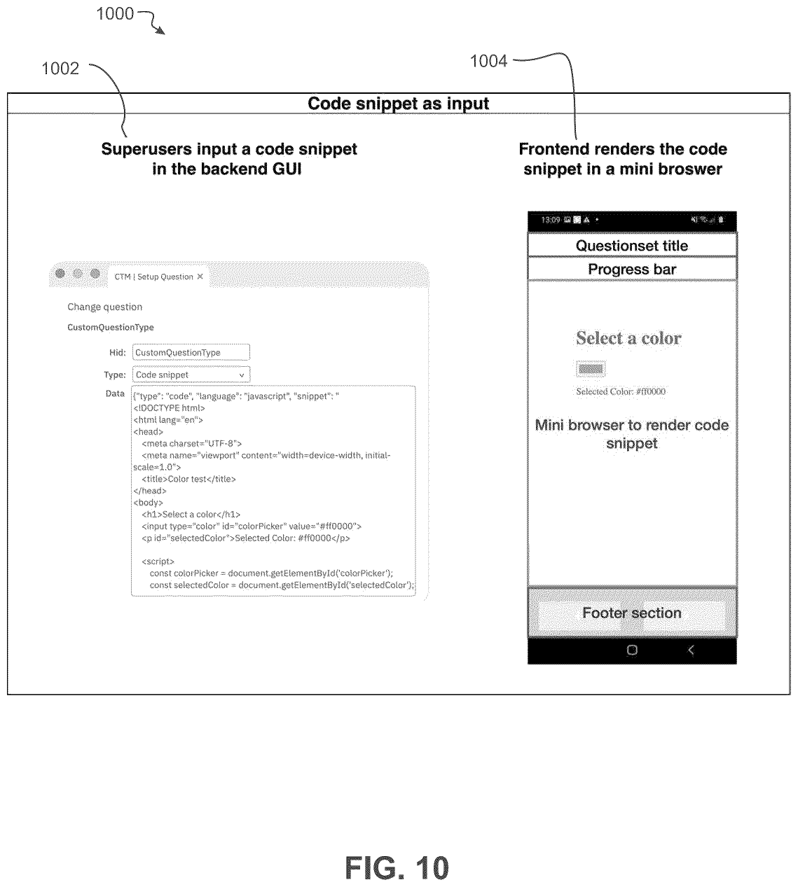

According to embodiments, and as depicted in FIGS. 4 and 10, dynamic rendering may include receiving at least one code snippet as input for generating a UI including task prompts and input prompts. A cross-platform development framework may be utilized to allow the superuser to write their code snippet in JavaScript CSS, HTML, or Objective-C. The system may determine if a code snippet is in Javascript, CSS, HTML, or Objective-C; format the code snippet into JSON format; and compile the code snippet. For example, a superuser may input a code snippet relating to a particular task prompt within the back-end UI which may be communicated to a front-end platform that may render the code snippet within a web browser as a user-facing UI shown on a display of a computing device.

In embodiments, code snippets may be utilized by superusers in web browser-based front-end platforms including coding customized widgets in Javascript, CSS, HTML, or Objective-C. The system may process superuser code snippets and modify the payload to include the provided code snippet and send the modified payload to the front-end platform and render customized widgets in a UI based on the code snippets in a web browser.

In embodiments, code snippets may be utilized by superusers in mobile software application platforms or mobile interfaces including coding customized widgets in Javascript, CSS, HTML, or Objective-C. A backend service may accept data from the superuser input, package it with rendering instructions, compile the information as needed depending on frontend type, and then distribute the packaged rendering-ready payload to the frontend. The system may perform back-end service checks of the code snippet format to determine superuser credentials or to verify the format of a code snippet, and send the code snippet to the front-end platform where a front-end platform may compile the code snippet and render the customized widgets in the mobile front-end platform. Code snippets may be input in JavaScript, CSS, or HTML format such that they may be formatted into rendering instructions by back-end services and processed by front-end user-facing web browsers directly to generate a user-facing UI.

In embodiments, a computer-implemented method may include receiving, by a processor set and through a back-end UI, input data including at least one prompt type and at least one associated answer type, wherein the at least one prompt type and at least one associated answer type define aspects of a front-end UI; generating, by the processor set, rendering instructions based on the at least one prompt type and at least one associated answer type; receiving, by the processor set and from a front-end platform, a request to view the front-end UI; and in response to receiving the request to view the front-end UI, communicating, by the processor set, the rendering instructions to the front-end platform, wherein the rendering instructions cause the front-end platform to dynamically render the front-end UI. Aspects of the present invention improve the process of constructing front-end UI's by allowing superusers to provide code snippets as part of their data content when generating a UI or by front-end UI layout template generation and widgets dynamically constructed based on both non-code input resulting in increased flexibility for generating UIs and expanding a system's useful lifespan.

In embodiments, a computer-implemented method may include generating the rendering instructions includes converting the at least one prompt type and the at least one associated answer type into a JavaScript Object Notation (JSON) formatted input data. Aspects of the present invention improve the process of constructing front-end UI's by systematically formatting prompt and answer types in JSON input data without the need for a user to have coding language knowledge.

In embodiments, a computer-implemented method may include generating the rendering instructions includes parsing the JSON formatted input data into at least one pre-built widget. Aspects of the present invention improve the process of constructing front-end UI's by systematically creating pre-built widgets based on JSON input data.

In embodiments, a computer-implemented method may include communicating the rendering instructions includes communicating the at least one pre-built widget to the front-end platform, wherein the at least one pre-built widget causes the front-end platform to dynamically render the front-end user interface. Aspects of the present invention improve the process of constructing front-end UI's rendering pre-built widgets based on JSON input data.

In embodiments, a computer-implemented method may include detecting credentials of a superuser at the back-end user interface; and detecting whether the front-end user is using a web-based interface that supports at least one language selected from a group consisting of Cascading Style Sheets (CSS), JavaScript, and Hypertext Markup Language (HTML), or a mobile interface. Aspects of the present invention improve the process of constructing front-end UI's by automatically identifying web-based user interfaces in order to properly render a UI.

In embodiments, a computer-implemented method may include, in response to detecting that the web-based interface supports at least one language selected from a group consisting of CSS, JavaScript, and HTML: receiving at least one code snippet as user input; parsing the at least one code snippet; modifying the at least one code snippet into JSON format; and wherein communicating the rendering instructions to the front-end platform includes communicating a modified code snippet to the front-end platform, wherein the modified code snippet causes the front-end platform to dynamically render the front-end user interface. Aspects of the present invention improve the process of constructing front-end UI's by allowing superusers to provide code snippets as part of their data content when generating a UI or by front-end UI layout template generation based on a web-based interface.

In embodiments, a computer-implemented method may include, in response to detecting that the web-based interface supports a mobile interface: performing at least one back-end service check of at least one code snippet; wherein communicating the rendering instructions includes communicating the at least one code snippet to the front-end platform; and compiling the at least one code snippet wherein the at least one code snippet causes the front-end platform to dynamically render the front-end user interface. Aspects of the present invention improve the process of constructing front-end UI's by compiling the information as needed depending on web-based interface type, and distributing a code snippet, as a packaged rendering-ready payload to the frontend.

In embodiments, a computer-implemented method may include receiving at least one code snippet in at least one of JavaScript or CSS via a cross-platform development framework. Aspects of the present invention improve the process of constructing front-end UI's by allowing users to use a single codebase compatible to work with several different operating systems.

In embodiments, a computer-implemented method may include rendering instructions causing the front-end platform to dynamically render the front-end user interface by causing the front-end platform to dynamically render a plurality of different types of user interaction components configured to cause at least one action selected from a group consisting of receive at least one input and generate at least one output. Aspects of the present invention improve the process of generating a UI including template and widget generation to receive user input.

In embodiments, a computer program product may include one or more computer readable storage media having program instructions collectively stored on the one or more computer readable storage media. The program instructions are executable to: receive, through a back-end user interface, input data including at least one prompt type and at least one associated answer type, wherein the at least one prompt type and at least one associated answer type define aspects of a front-end user interface; generate rendering instructions based on the at least one prompt type and at least one associated answer type; receive, from a front-end platform, a request to view the front-end user interface; and in response to receiving the request to view the front-end user interface, communicate the rendering instructions to the front-end platform, wherein the rendering instructions cause the front-end platform to dynamically render the front-end user interface. Aspects of the present invention improve the process of constructing front-end UI's by allowing superusers to provide code snippets as part of their data content when generating a UI or by front-end UI layout template generation and widgets dynamically constructed based on both non-code input resulting in increased flexibility for generating UIs and expanding a system's useful lifespan.

In embodiments, a computer program product is disclosed wherein generating the rendering instructions includes converting the at least one prompt type and the at least one associated answer type into a JavaScript Object Notation (JSON) formatted input data. Aspects of the present invention improve the process of constructing front-end UI's by systematically formatting prompt and answer types in JSON input data without the need for a user to have coding language knowledge.

In embodiments, a computer program product is disclosed wherein generating the rendering instructions includes parsing the JSON formatted input data into at least one pre-built widget. Aspects of the present invention improve the process of constructing front-end UI's by systematically creating pre-built widgets based on JSON input data.

In embodiments, a computer program product is disclosed wherein communicating the rendering instructions includes communicating the at least one pre-built widget to the front-end platform, wherein the at least one pre-built widget causes the front-end platform to dynamically render the front-end user interface. Aspects of the present invention improve the process of constructing front-end UI's rendering pre-built widgets based on JSON input data.

In embodiments, a computer program product may include detecting credentials of a superuser at the back-end user interface; and detecting whether the front-end user is using a web-based interface that supports at least one language selected from a group consisting of Cascading Style Sheets (CSS), JavaScript, and Hypertext Markup Language (HTML), or a mobile interface. Aspects of the present invention improve the process of constructing front-end UI's by automatically identifying web-based user interfaces in order to properly render a UI.

In embodiments, a computer program product may include, in response to detecting that the web-based interface supports at least one language selected from a group consisting of CSS, JavaScript, and HTML, program executable to receive at least one code snippet as user input; parse the at least one code snippet; modify the at least one code snippet into JSON format; and wherein communicating the rendering instructions to the front-end platform includes communicating a modified code snippet to the front-end platform, wherein the modified code snippet causes the front-end platform to dynamically render the front-end user interface. Aspects of the present invention improve the process of constructing front-end UI's by allowing superusers to provide code snippets as part of their data content when generating a UI or by front-end UI layout template generation based on a web-based interface.

In embodiments, a computer program product may include, in response to detecting that the web-based interface supports a mobile interface: performing at least one back-end service check of at least one code snippet; wherein communicating the rendering instructions includes communicating the at least one code snippet to the front-end platform; and compile the at least one code snippet wherein the at least one code snippet causes the front-end platform to dynamically render the front-end user interface. Aspects of the present invention improve the process of constructing front-end UI's by compiling the information as needed depending on web-based interface type, and distributing a code snippet, as a packaged rendering-ready payload to the frontend.

In embodiments, a computer program product may include program instructions that are executable to receive at least one code snippet in at least one of JavaScript or CSS via a cross-platform development framework. Aspects of the present invention improve the process of constructing front-end UI's by allowing users to use a single codebase compatible to work with several different operating systems.

In embodiments, a computer program product may include rendering instructions to cause the front-end platform to dynamically render the front-end user interface by causing the front-end platform to dynamically render a plurality of different types of user interaction components configured to cause at least one action selected from a group consisting of receive at least one input and generate at least one output. Aspects of the present invention improve the process of generating a UI including template and widget generation to receive user input.

In embodiments, a system may include a processor set, one or more computer readable storage media, and program instructions collectively stored on the one or more computer readable storage media. The program instructions are executable to: receive, through a back-end user interface, input data including at least one prompt type and at least one associated answer type, wherein the at least one prompt type and at least one associated answer type define aspects of a front-end user interface; generate rendering instructions based on the at least one prompt type and at least one associated answer type; receive, from a front-end platform, a request to view the front-end user interface; and in response to receiving the request to view the front-end user interface, communicate the rendering instructions to the front-end platform, wherein the rendering instructions cause the front-end platform to dynamically render the front-end user interface. Aspects of the present invention improve the process of constructing front-end UI's by allowing superusers to provide code snippets as part of their data content when generating a UI or by front-end UI layout template generation and widgets dynamically constructed based on both non-code input resulting in increased flexibility for generating UIs and expanding a system's useful lifespan.

In embodiments, the system may generate the rendering instructions including converting at least one prompt type and the at least one associated answer type into a JavaScript Object Notation (JSON) formatted input data. Aspects of the present invention improve the process of constructing front-end UI's by allowing superusers to provide code snippets as part of their data content when generating a UI or by front-end UI layout template generation and widgets dynamically constructed based on both non-code input resulting in increased flexibility for generating UIs and expanding a system's useful lifespan.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

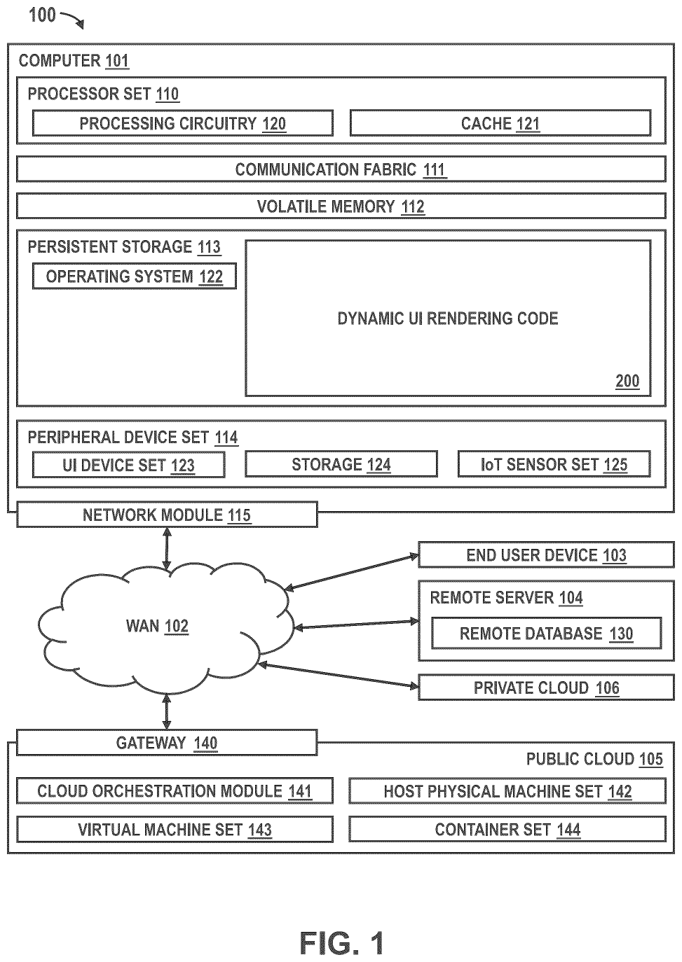

Referring to FIG. 1, computing environment 100 contains an example of an environment for the execution of at least some of the computer code involved in performing the inventive methods, such as dynamic UI rendering code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

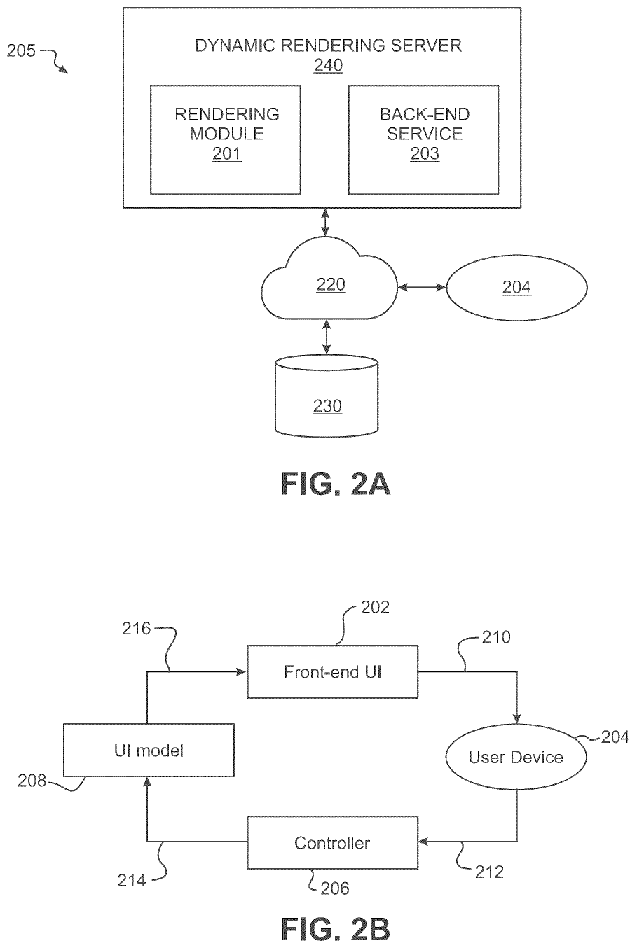

FIG. 2A depicts an exemplary environment 205 in accordance with aspects of the invention. In embodiments, the environment includes dynamic rendering server 240 including or in communication with dynamic UI rendering module 201, corresponding to the computer 101 and dynamic UI rendering code 200, as in FIG. 1. The dynamic rendering server 240 includes or is in communication with the dynamic UI rendering module 201 and the back-end service 203 for rendering a back-end UI and an interface to a front-end user device 204, corresponding to end-user device 103 of FIG. 1, connected to a network 220. The dynamic rendering server 240 may be configured to communicate with a plurality of different user computer devices 204 simultaneously. The environment 205 includes at least one database 230 in operable communication with the dynamic rendering server 240 over network 220, corresponding to WAN 102 of FIG. 1. The database 230, corresponding to remote server 104 or remote database 130 of FIG. 1, may store predefined widgets corresponding to front-end UI elements, such as interaction components. The exemplary environment 205 may include a request to view an interface on the user device 204; receive superuser data via a back-end UI 201; and dynamically render an interface on the user device 204, corresponding to end-user device 103 of FIG. 1, based on the superuser data.

In embodiments, the dynamic rendering server 240 of FIG. 2A includes rendering module 201 and back-end service 203, each of which may include modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The dynamic rendering server 240 may include additional or fewer modules than those shown in FIG. 2A. In embodiments, separate modules may be integrated into a single module. Additionally, or alternatively, a single module may be implemented as multiple modules. Moreover, the quantity of devices and/or networks in the environment is not limited to what is shown in FIG. 2A. In practice, the environment may include additional devices and/or networks; fewer devices and/or networks; different devices and/or networks; or differently arranged devices and/or networks than illustrated in FIG. 2A.

FIG. 2B depicts an exemplary environment of an MVC software architecture pattern for dynamically rendering, via the dynamic rendering server 240 of FIG. 2A, UIs including at least one user device 204 accessing 212 a controller 206 that may manipulate 214 a UI model 208 which, based on user input and manipulation via the back-end service 203, may dynamically render 216 via the rendering module 201, a front-end UI 202 which may be displayed 210 to the at least one user device 204.

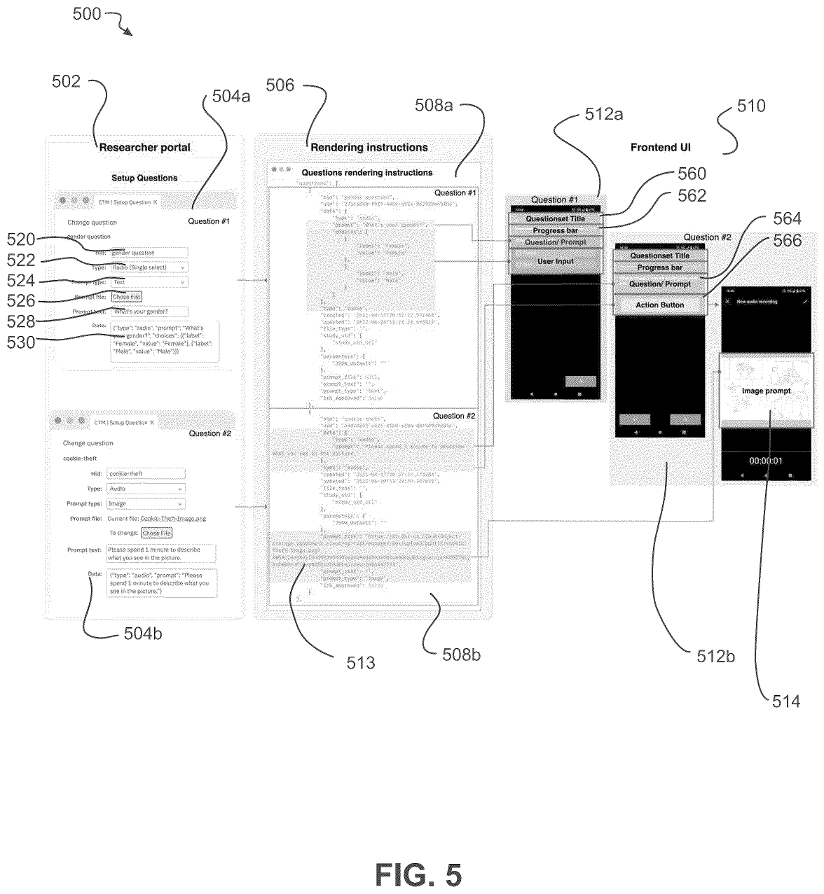

FIG. 3 depicts an exemplary method 300 in accordance with aspects of the present invention and as described with respect to FIGS. 2A and 2B. Steps of the method may be carried out in the environment of FIG. 2A or 2B and are described with reference to elements depicted in FIGS. 2A and 2B. At step 302, the system may display a back-end UI including prompts 304 including questions prompts and input prompts, as depicted in FIGS. 5-10 as 520 and 522, respectively. Input prompts may include simple input prompts 306, such as text input prompts, or complex input prompts 308, such as image data input prompts, video data input prompts, audio data input prompts, or the like. At step 310, the system may receive superuser input in the form of task prompts including predefined question type widgets or user code snippets. If the system receives code snippets as user input 312, the system may parse code snippets 400 as depicted in FIG. 4. In embodiments, code snippets, optionally in JavaScript or CSS format, may be received via a cross-platform development framework, as previously described. If the system receives superuser input for task type widgets 314, the system back-end may parse the superuser input data into JSON format 316, which may be communicated to a front-end platform 318 which may include front-end user device 204. The front-end platform 318 may then render predefined widgets as UI elements 320 including superuser input variables.

FIG. 4 depicts an exemplary method 400 in accordance with aspects of the present invention and as described with respect to FIG. 2A, 2B, and FIG. 3. As depicted in FIG. 3, at step 312, the system may receive code snippets as user input and the system may parse code snippets to determine if the UI to be generated will be displayed on a web-based browser on a display or in a mobile application on a display, such as via a back-end service check of the code snippet. If the UI to be generated will be displayed on a web-based browser, the system may receive trusted superuser JavaScript, CSS, or HTML coding (or other web-based editing language) for a specific, customized widget 402. The system may process received code snippets 404, such as parsing the code snippet which may include parsing JSON formatted input data into at least one pre-built widget, modify the code snippet structure into JSON format 406 (including removal of unnecessary elements), such as converting the at least one prompt type and the at least one associated answer type into a JSON formatted input data, communicate the modified code snippet 408 to the front-end platform 401, corresponding to front-end platform 318 in FIG. 3, front-end user device 204 of FIG. 2, and end-user device 103 of FIG. 1, which may render customized UI widgets 410 based on the modified code snippet, such as in the form of rendering instructions. In embodiments, communicating modified code snippet 408 to the front-end platform 401, such as in the form of rendering instructions, may cause the front-end platform to dynamically render a front-end UI. In embodiments, communicating customized UI widgets 410, such as a pre-built widget in the form of rendering instructions, to the front-end platform 401 may cause the front-end platform 401 to dynamically render the front-end UI. In additional embodiments, rendering instructions cause the front-end platform 401 to dynamically render the front-end UI by causing the front-end platform 401 to dynamically render a plurality of different types of user interaction components, such as interaction components corresponding to UI widgets 410, configured to receive at least one input or generate at least one output.

According to embodiments, the system may also receive code snippets as user input, and the system may parse code snippets to determine if the UI to be generated will be displayed on a mobile application on a device display, such as via a back-end service check of the code snippet. If the UI to be generated will be displayed on a mobile application, the system may receive trusted superuser JavaScript, CSS, or HTML coding for a specific, customized widget 412 in a standardized framework, such as a virtual web browser instance. The system may determine 414 if a received code snippet is in JavaScript, CSS, HTML, or Objective-C format, modify the code snippet structure into JSON format 416, communicate the modified code snippet 418 to the front-end platform 401, compile the modified code snippet, and render customized UI widgets 420 based on modified code snippet 418 in a standardized framework. In embodiments, compiling the modified code snippet 418 causes the front-end platform 401 to dynamically render a front-end UI.

FIG. 5 depicts an exemplary method 500 including a back-end UI 502 including task prompts 504a, 504b for dynamically rendering a front-end UI 510 corresponding to front-end UI 202 of FIG. 2. Superusers may provide task prompts 504a, 504b after detecting or receiving the credentials of a superuser at the back-end UI, such as, for example, via superuser login credentials or administrator designation of a superuser with task prompt input permissions. In embodiments, detecting credentials of a superuser at the back-end UI may include detecting whether the front-end user is using a web-based interface that supports at least one language selected from a group consisting of CSS, JavaScript, and HTML, or a mobile interface.

Task prompts 504a, 504b may be singular or plural. Each task prompt 504a, 504b may include input data such as task input 520, answer type 522, prompt type 524, prompt file 526, prompt text 528, and data 530.

Task input 520 may be an auto-populating text input field indicating the name or order of tasks associated with the task prompts 504a, 504b. As a non-limiting example, task input 520 may be auto-populated based on input to prompt text 528.

Prompt type 524 may be a text input field or drop-down menu including a variety of prompt or question types to be rendered in a front-end UI including as non-limiting examples, text, audio recordings, video recordings, or the like. Prompt type 524 input determines the rendering of a predefined widget as a question or prompt to which answer type 522 serves as the answer. The system may include predefined templates for each prompt type 524.

Answer type 522 may be a text input field or drop-down menu including a variety of answer types to be rendered in a front-end UI including, as non-limiting examples, text input fields, radio buttons, recording of audio or video, or the like. Answer type 522 input determines the rendering of a predefined widget as a response to prompt type 524. The system may include predefined templates for each answer type 522.

Prompt file 526 may be configured to render a predefined widget as part of a response to prompt type 524, such as, but not limited to, allowing a front-end user to upload files such as images, audio recordings, video recordings, or the like.

Prompt text 528 may be a text input field configured to receive superuser text input to determine rendering of tasks 512a, 512b. For example, and as depicted in FIG. 5, a superuser may input “What is your gender?” in the prompt text 528 field which may be rendered as part or whole of a predefined widget as a question or prompt to which answer type 522 serves as the answer.

Data 530 may include a text input field including autogenerated text based on inputs for task input 520, answer type 522, prompt type 524, prompt file 526, and prompt text 528. Data 530 may autogenerate JSON-compliant code to be communicated as rendering instructions 506 including task-specific rendering instructions 508a, 508b for each task prompt 504a, 504b including JSON-compliant instructions 513 in the process of dynamically rendering UI elements in a front-end UI 510. Data 530 may be editable within the text input field of data 530 or used as a code snippet for generating unique or customized UI elements.

A front-end platform corresponding to user device 204 in FIG. 2A, including front-end UI 510 may receive JSON-compliant instructions 513 and render end-user facing UI elements 512a, 512b corresponding to rendering instructions 508a, 508b for each task prompt 504a, 504b. End-user facing UI elements 512a, 512b may include elements such as, but not limited to, task titles 560 corresponding to task input 520; task progress 562 corresponding to task input 520; question/prompt 564 corresponding to prompt text 528 and prompt type 524; user input 566 corresponding to answer type 522; or file prompt 514 corresponding to prompt file 526.

As a non-limiting example, the method may include the step of receiving at least one prompt type and at least one associated answer type through a back-end UI. The prompt type 524 and answer type 522 may be a set of question-and-answer used in, for example, a survey. The method may include the step of receiving a request to view a survey, or the like, corresponding to the at least one prompt type 524 and at least one associated answer type 522 on a front-end UI. The request to view may be initiated via an end-user device requesting to view and access, for example, the previously mentioned survey. The method may include the step of dynamically rendering, via the dynamic rendering server 240 or dynamic UI rendering code of block 200, a front-end UI based on the at least one prompt type 524 and at least one associated answer type 522. The method may include the step of instructing an end-user device 103 to display, by the processor set, the front-end UI.

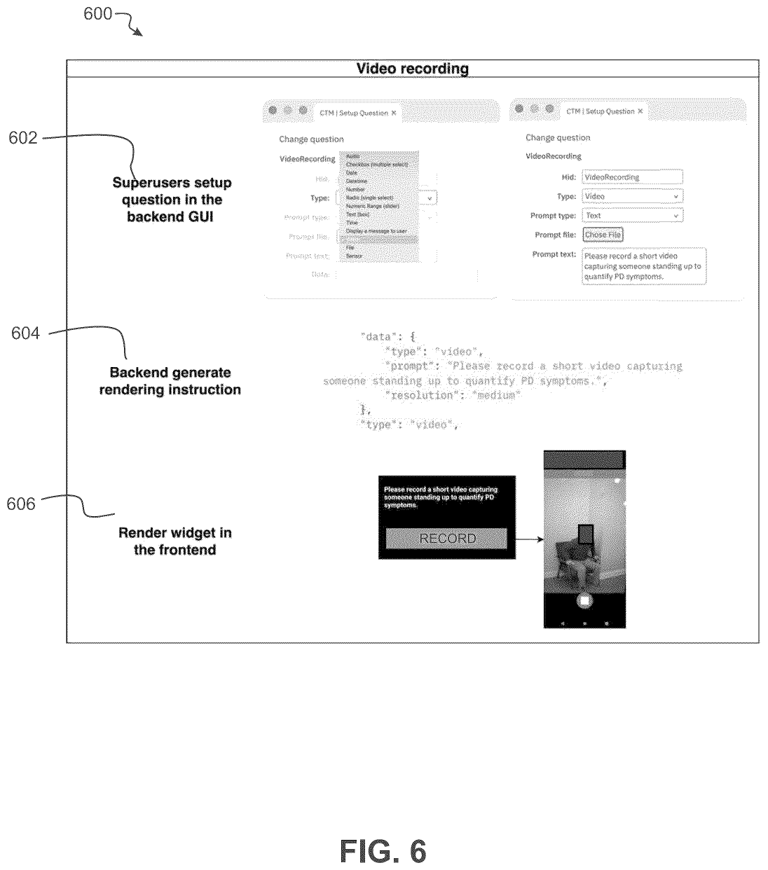

FIG. 6 depicts an exemplary method 600 for generating a UI requiring video recording or upload in response to a task or question, including a back-end UI 602, corresponding to back-end UI 302 of FIG. 3 and 502 of FIG. 5, configured for allowing superusers to establish tasks and inputs or questions and answers. Tasks or questions may be based on back-end generation of rendering instructions 604, corresponding to rendering instructions 506 of FIG. 506, including entry of task input, answer type, prompt type, prompt file, prompt text, and data as previously described in the description of FIG. 5. The system may render a widget in a front-end UI 606, corresponding to front-end UI 202 of FIG. 2 and 510 of FIG. 5, based on rendering instructions 604.

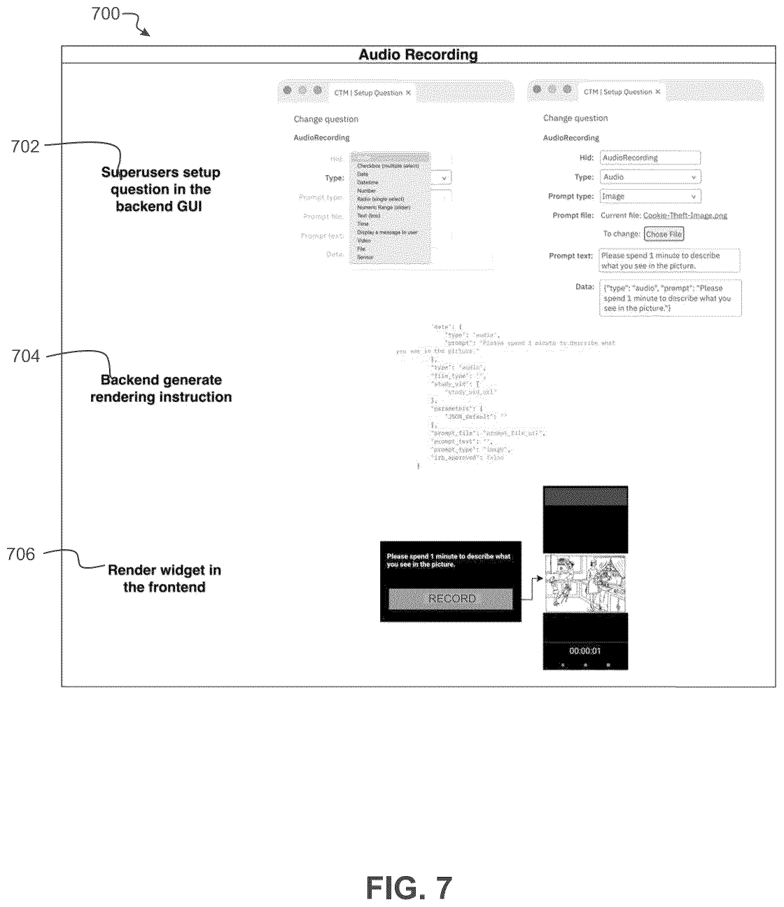

FIG. 7 depicts an exemplary method 700 for generating a UI requiring audio recording or upload in response to a task or question, including a back-end UI 602, corresponding to back-end UI 302 of FIG. 3 and 502 of FIG. 5, configured for allowing superusers to establish tasks or questions. Tasks or questions may be based on back-end generation of rendering instructions 704, corresponding to rendering instructions 506 of FIG. 506, including entry of task input, answer type, prompt type, prompt file, prompt text, and data as previously described in the description of FIG. 5. The system may render a widget in a front-end UI 706, corresponding to front-end UI 202 of FIG. 2 and 510 of FIG. 5, based on rendering instructions 704.

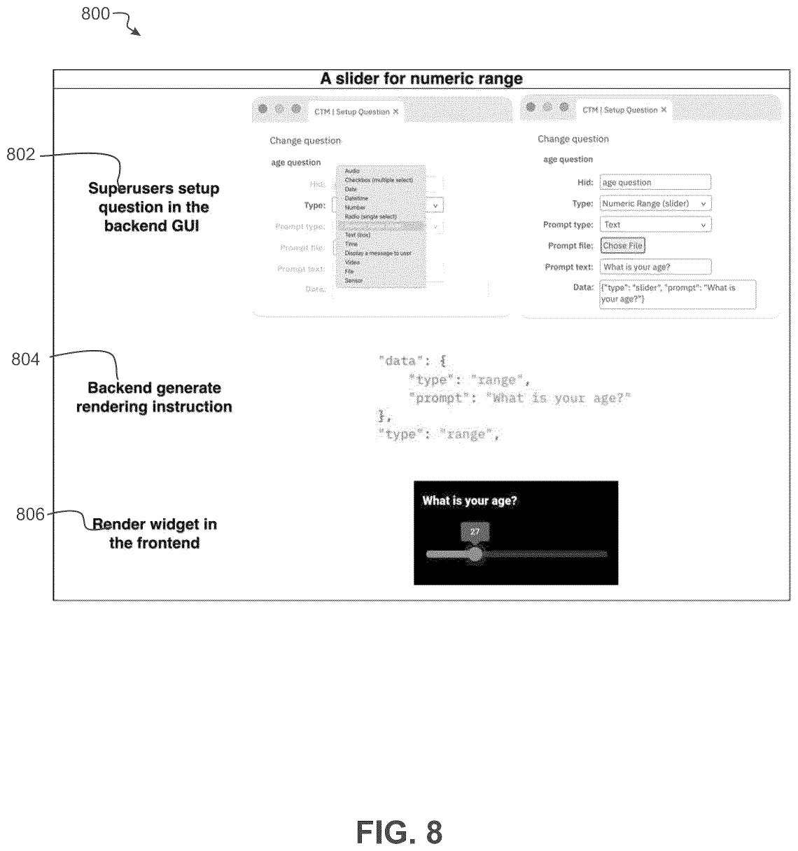

FIG. 8 depicts an exemplary method 800 for generating a UI requiring front-end user input in the form of slider interaction in response to a task or question, including a back-end UI 802, corresponding to back-end UI 302 of FIG. 3 and 502 of FIG. 5, configured for allowing superusers to establish tasks or questions. Tasks or questions may be based on back-end generation of rendering instructions 804, corresponding to rendering instructions 506 of FIG. 506, including entry of task input, answer type, prompt type, prompt file, prompt text, and data as previously described in the description of FIG. 5. The system may render a widget in a front-end UI 806, corresponding to front-end UI 202 of FIG. 2 and 510 of FIG. 5, based on rendering instructions 804.

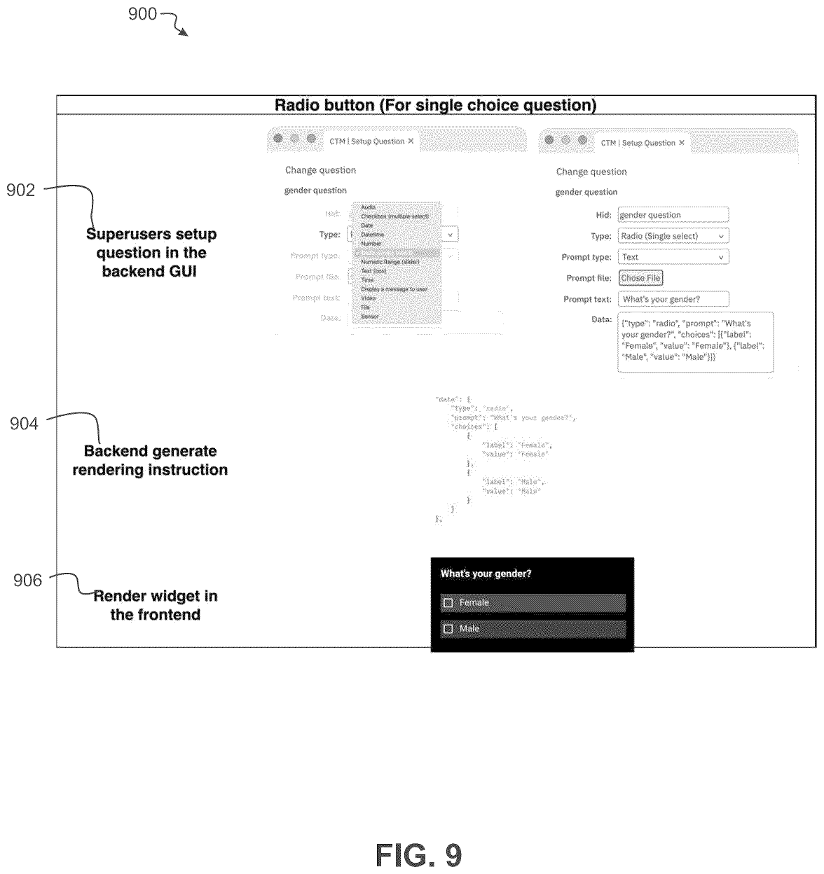

FIG. 9 depicts an exemplary method 900 for generating a UI requiring user interaction with a toggle or radio button in response to a task or question, including a back-end UI 902, corresponding to back-end UI 302 of FIG. 3 and 502 of FIG. 5, configured for allowing superusers to establish tasks or questions. Tasks or questions may be based on back-end generation of rendering instructions 904, corresponding to rendering instructions 506 of FIG. 506, including entry of task input, answer type, prompt type, prompt file, prompt text, and data as previously described in the description of FIG. 5. The system may render a widget in a front-end UI 906, corresponding to front-end UI 202 of FIG. 2 and 510 of FIG. 5, based on rendering instructions 904.

FIG. 10 depicts an exemplary method 1000 for generating a UI based on code snippet input provided via a back-end UI. Dynamic rendering may include receiving at least one code snippet 1002, corresponding to code snippet 400 of FIG. 4, as input for generating a UI including task prompts and input prompts. Code snippets may be received in JavaScript, CSS, or HTML. The system may determine if a code snippet is in JavaScript, CSS, HTML, or Objective-C; format the code snippet into JSON compliant format; compile the code snippet; and render the code snippet as a UI or UI elements 1004, corresponding to UI elements 320 of FIG. 3, within a web browser or mobile application shown on a display of a computing device.

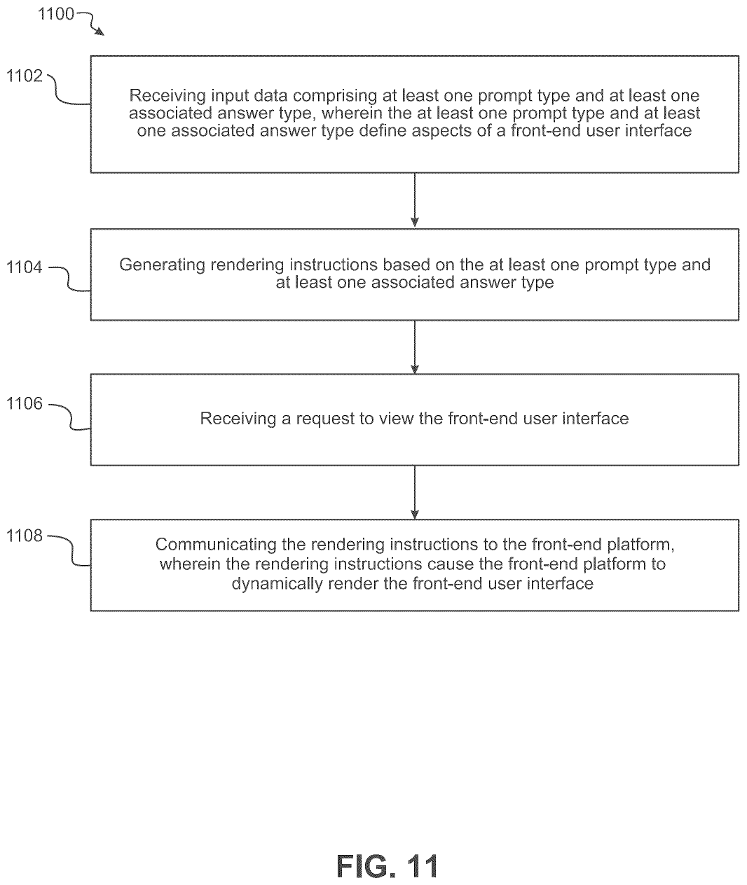

FIG. 11 depicts a flowchart of program instructions 1100 executed by a system including a processor set, one or more computer readable storage media, and program instructions collectively stored on the one or more computer readable storage media. The program instructions executable to receive 1102, by a processor set and through a back-end UI, input data including at least one prompt type and at least one associated answer type, wherein the at least one prompt type and at least one associated answer type define aspects of a front-end UI; generate 1104, by the processor set, rendering instructions based on the at least one prompt type and at least one associated answer type; receive 1106, by the processor set and from a front-end platform, a request to view the front-end UI; and in response to receiving the request to view the front-end UI, communicate 1108, by the processor set, the rendering instructions to the front-end platform, wherein the rendering instructions cause the front-end platform to dynamically render the front-end UI.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can include one or more of (1) installing program code on a computing device, such as the computer 101 of FIG. 1, from a computer-readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set and through a back-end user interface, input data comprising at least one prompt type and at least one associated answer type, wherein the at least one prompt type and at least one associated answer type define aspects of a front-end user interface;
generating, by the processor set, rendering instructions based on the at least one prompt type and at least one associated answer type;
receiving, by the processor set and from a front-end platform, a request to view the front-end user interface; and
in response to receiving the request to view the front-end user interface, communicating, by the processor set, the rendering instructions to the front-end platform, wherein the rendering instructions cause the front-end platform to dynamically render the front-end user interface.

2. The computer-implemented method of claim 1, wherein generating the rendering instructions comprises converting the at least one prompt type and the at least one associated answer type into a JavaScript Object Notation (JSON) formatted input data.

3. The computer-implemented method of claim 2, wherein generating the rendering instructions comprises parsing the JSON formatted input data into at least one pre-built widget.

4. The computer-implemented method of claim 3, wherein communicating the rendering instructions comprises communicating the at least one pre-built widget to the front-end platform, wherein the at least one pre-built widget causes the front-end platform to dynamically render the front-end user interface.

5. The computer-implemented method of claim 1, further comprising:
detecting credentials of a superuser at the back-end user interface; and
detecting whether the front-end user is using a web-based interface that supports at least one language selected from a group consisting of Cascading Style Sheets (CSS), JavaScript, and Hypertext Markup Language (HTML), or a mobile interface.

6. The computer-implemented method of claim 5 further comprising, in response to detecting that the web-based interface supports at least one language selected from a group consisting of CSS, JavaScript, and HTML:
receiving at least one code snippet as user input;
parsing the at least one code snippet;
modifying the at least one code snippet into JSON format; and
wherein communicating the rendering instructions to the front-end platform comprises communicating a modified code snippet to the front-end platform, wherein the modified code snippet causes the front-end platform to dynamically render the front-end user interface.

7. The computer-implemented method of claim 5, further comprising, in response to detecting that the web-based interface supports a mobile interface:
performing at least one back-end service check of at least one code snippet;
wherein communicating the rendering instructions comprises communicating the at least one code snippet to the front-end platform; and
compiling the at least one code snippet wherein the at least one code snippet causes the front-end platform to dynamically render the front-end user interface.

8. The computer-implemented method of claim 5, further comprising receiving at least one code snippet in at least one of JavaScript or CSS via a cross-platform development framework.

9. The computer-implemented method of claim 1, wherein the rendering instructions cause the front-end platform to dynamically render the front-end user interface by causing the front-end platform to dynamically render a plurality of different types of user interaction components configured to cause at least one action selected from a group consisting of receive at least one input and generate at least one output.

10. A computer program product comprising one or more computer readable storage media having program instructions collectively stored on the one or more computer readable storage media, the program instructions executable to:
receive, through a back-end user interface, input data comprising at least one prompt type and at least one associated answer type, wherein the at least one prompt type and at least one associated answer type define aspects of a front-end user interface;
generate rendering instructions based on the at least one prompt type and at least one associated answer type;
receive, from a front-end platform, a request to view the front-end user interface; and
in response to receiving the request to view the front-end user interface, communicate the rendering instructions to the front-end platform, wherein the rendering instructions cause the front-end platform to dynamically render the front-end user interface.

11. The computer program product of claim 10, wherein generating the rendering instructions comprises converting the at least one prompt type and the at least one associated answer type into a JavaScript Object Notation (JSON) formatted input data.

12. The computer program product of claim 11, wherein generating the rendering instructions comprises parsing the JSON formatted input data into at least one pre-built widget.

13. The computer program product of claim 12, wherein communicating the rendering instructions comprises communicating the at least one pre-built widget to the front-end platform, wherein the at least one pre-built widget causes the front-end platform to dynamically render the front-end user interface.

14. The computer program product of claim 13, wherein the program instructions are executable to:
detect credentials of a superuser at the back-end user interface; and
detect whether the front-end user is using a web-based interface that supports at least one language selected from a group consisting of Cascading Style Sheets (CSS), JavaScript, and Hypertext Markup Language (HTML), or a mobile interface.

15. The computer program product of claim 14, wherein the program instructions are executable to, in response to detecting that the web-based interface supports at least one language selected from a group consisting of CSS, JavaScript, and HTML:
receive at least one code snippet as user input;
parse the at least one code snippet;
modify the at least one code snippet into JSON format; and
wherein communicating the rendering instructions to the front-end platform comprises communicating a modified code snippet to the front-end platform, wherein the modified code snippet causes the front-end platform to dynamically render the front-end user interface.

16. The computer program product of claim 14, wherein the program instructions are executable to, in response to detecting that the web-based interface supports a mobile interface:
perform at least one back-end service check of at least one code snippet;
wherein communicating the rendering instructions comprises communicating the at least one code snippet to the front-end platform; and
compile the at least one code snippet wherein the at least one code snippet causes the front-end platform to dynamically render the front-end user interface.

17. The computer program product of claim 14, wherein the program instructions are executable to receive at least one code snippet in at least one of JavaScript or CSS via a cross-platform development framework.

18. The computer program product of claim 14, wherein the rendering instructions cause the front-end platform to dynamically render the front-end user interface by causing the front-end platform to dynamically render a plurality of different types of user interaction components configured to cause at least one action selected from a group consisting of receive at least one input and generate at least one output.

19. A system comprising:
a processor set, one or more computer readable storage media, and program instructions collectively stored on the one or more computer readable storage media, the program instructions executable to:
receive, through a back-end user interface, input data comprising at least one prompt type and at least one associated answer type, wherein the at least one prompt type and at least one associated answer type define aspects of a front-end user interface;
generate rendering instructions based on the at least one prompt type and at least one associated answer type;
receive, from a front-end platform, a request to view the front-end user interface; and
in response to receiving the request to view the front-end user interface, communicate the rendering instructions to the front-end platform, wherein the rendering instructions cause the front-end platform to dynamically render the front-end user interface.

20. The system of claim 19, wherein generating the rendering instructions comprises converting the at least one prompt type and the at least one associated answer type into a JavaScript Object Notation (JSON) formatted input data.
